(19) United States
(12) Patent Application Publication
(10) Pub. No.: US 2016/0249215 A1
(43) Pub. Date: Aug. 25, 2016

(54) COMMUNICATION CONTROL METHOD, AUTHENTICATION SERVER, AND USER TERMINAL

(71) Applicant: KYOCERA CORPORATION, Kyoto (JP)

(72) Inventor: Kugo MORITA, Yokohama-shi, Kanagawa (JP)

(73) Assignee: KYOCERA CORPORATION, Kyoto (JP)

(21) Appl. No.: 15/031,180

(22) PCT Filed: Oct. 23, 2014
(86) PCT No.: PCT/JP2014/078242

§ 371 Date: Apr. 21, 2016

(30) Foreign Application Priority Data
Oct. 29, 2013 (JP) 2013-224470

(51) Int. Cl. H04W 12/06; H04W 12/04

(52) U.S. Cl. CPC H04W 12/06; H04W 12/04

(57) ABSTRACT

A communication control method according to the present invention comprises: a first transmission step of transmitting, by a first authentication server in a first communication system, a first encryption key, to a user terminal; a second transmission step of transmitting, by the user terminal, first terminal information on the user terminal in the first communication system to a second authentication server in a second communication system; a third transmission step of transmitting, by the second authentication server, the first terminal information encrypted by using the first encryption key, to the first authentication server; and a determination step of determining, by the first authentication server, that the second authentication server is a valid authentication server for the user terminal, when the first authentication server has acquired the first terminal information by using a first decryption key capable of decrypting information encrypted by the first encryption key.

### TECHNICAL FIELD

The present invention relates to a communication control method for confirming that an authentication server is valid for a user terminal between different communication systems, an authentication server therefore, and a user terminal therefore.

### BACKGROUND ART

In 3GPP (3rd Generation Partnership Project) which is a project aiming to standardize a cellular communication system, it is planned to consider a technology capable of strengthening cooperation between a cellular communication system and a Wireless LAN system (see Non Patent Document 1).

For example, a method may be considered where a traffic exchanged between a user terminal and a cellular base station is transitioned (that is, offloaded) to a Wireless LAN system so as to disperse a traffic load in the cellular base station to the Wireless LAN system.

### PRIOR ART DOCUMENT

### Non-Patent Document

Non Patent Document 1: 3GPP contribution RP-1201455

### SUMMARY OF THE INVENTION

In order to perform an effective offload between a cellular communication system and a Wireless LAN system, it is necessary that authentication servers in these systems work together so as to authenticate a user terminal for which the offload is executed.

However, when the authentication server in the other system lacks reliability as a valid authentication server for the user terminal, if the authentication servers work together, information on the user terminal may be leaked, resulting in a user experiencing a possible disadvantage.

This problem may occur between the cellular communication system and the Wireless LAN system, and in addition, a similar problem may also occur between other radio communication systems.

Therefore, the present invention provides a communication control method with which it is possible to secure reliability that an authentication server in another system is a valid authentication server for a user terminal between authentication servers in different radio communication systems, and provides also an authentication server therefore and a user terminal therefore.

### MEANS OF SOLVING THE PROBLEMS

A communication control method according to an embodiment comprises: a first transmission step of transmitting, by a first authentication server in a first communication system, a first encryption key, to a user terminal; a second transmission step of transmitting, by the user terminal, first terminal information on the user terminal in the first communication system to a second authentication server in a second communication system; a third transmission step of transmitting, by the second authentication server, the first terminal information encrypted by using the first encryption key, to the first authentication server; and a determination step of determining, by the first authentication server, that the second authentication server is a valid authentication server for the user terminal, when the first authentication server has acquired the first terminal information by using a first decryption key capable of decrypting information encrypted by the first encryption key.

### BRIEF DESCRIPTION OF THE DRAWINGS

FIG. 1 is a system configuration diagram according to an embodiment.

FIG. 2 is a block diagram of a UE (user terminal) according to the embodiment.

FIG. 3 is a block diagram of an eNB (cellular base station) according to the embodiment.

FIG. 4 is a block diagram of an AP (access point) according to the embodiment.

FIG. 5 is a protocol stack diagram of a radio interface in an LTE system.

FIG. 6 is a diagram for describing an operation environment according to the embodiment.

FIG. 7 is a diagram for describing an operation sequence of setting an authentication target according to the embodiment.

FIG. 8 is a diagram for describing an operation sequence of updating an authentication target according to the embodiment.

FIG. 9 is a diagram for describing an operation sequence of setting an authentication target according to a modification of the embodiment.

FIG. 10 is a diagram for describing an operation sequence of setting the authentication target according to the modification of the embodiment.

FIG. 11 is a diagram for describing an operation sequence of setting the authentication target according to the modification of the embodiment.

FIG. 12 is a diagram for describing an operation sequence of setting the authentication target according to the modification of the embodiment.

### DESCRIPTION OF THE EMBODIMENT

[Overview of Embodiment]

A communication control method according to an embodiment comprises: a first transmission step of transmitting, by a first authentication server in a first communication system, a first encryption key, to a user terminal; a second transmission step of transmitting, by the user terminal, first terminal information on the user terminal in the first communication system to a second authentication server in a second communication system; a third transmission step of transmitting, by the second authentication server, the first terminal information encrypted by using the first encryption key, to the first authentication server; and a determination step of determining, by the first authentication server, that the second authentication server is a valid authentication server for the user terminal, when the first authentication server has acquired the first terminal information by using a first decryption key capable of decrypting information encrypted by the first encryption key.

Here, the “valid authentication server for the user terminal” means a authentication server configured to allow the user terminal to connect a communication system. Alternatively, the “valid authentication server for the user terminal” may mean a authentication server controlled by a communication operator that make an agreement of a communication system with a user of the user terminal.

In the embodiment, in the second transmission step, the user terminal transmits, together with the first terminal information, the first encryption key received from the first authentication server, to the second authentication server. The communication control method further comprises: a step of encrypting, by the second authentication server, the first terminal information by using the first encryption key received from the user terminal.

In the embodiment, a communication operator that manages the first authentication server is different from a communication operator that manages the second authentication server.

The communication control method according to the embodiment further comprises: a request step of transmitting, by the user terminal, a request to the first authentication server before the first transmission step, the request being for causing to set the valid authentication server in the second communication system to the first authentication server. The request includes a user encryption key used for encryption of the first encryption key. In the first transmission step, when receiving the request from the user terminal, the first authentication server transmits the first encryption key encrypted by using the user encryption key to the user terminal.

In the embodiment, in the request step, when being connected both to the first communication system and the second communication system, the user terminal transmits the request to the first authentication server.

In the embodiment of a modification, in the request step, when being connected only to the first communication system, the user terminal transmits the request to the first authentication server. In the second transmission step, when performing a connection to the second communication system, the user terminal transmits the first terminal information.

In the embodiment, in the second transmission step, the user terminal transmits, together with the first terminal information, the first encryption key received from the first authentication server, to the second authentication server. In the third transmission step, the second authentication server transmits authentication setting information to the first authentication server together with the first terminal information, the authentication setting information being used for authentication of the user terminal in the second authentication server and being encrypted by using the first encryption key. The communication control method further comprises the steps of: transmitting, by the first authentication server, instead of the user terminal, the authentication setting information to the second authentication server before transitioning a traffic of the user terminal from the first communication system to the second communication system; and authenticating, by the second authentication server, the user terminal, on the basis of the authentication setting information received from the first authentication server.

The communication control method according to the embodiment further comprises the steps of: transmitting, by the second authentication server, a second encryption key to the user terminal; transmitting, by the user terminal, second terminal information on the user terminal in the second communication system received from the second authentication server, to the first authentication server; transmitting, by the first authentication server, the second terminal information encrypted by using the second encryption key, to the second authentication server; and determining, by the second authentication server, that the first authentication server is the valid authentication server, when the second authentication server has acquired the second terminal information by using a second decryption key capable of decrypting information encrypted by using the second encryption key. In the third transmission step, the second authentication server transmits the first terminal information encrypted by using the first encryption key to the first authentication server, as a response to the second terminal information from the first authentication server when determining that the first authentication server is the valid authentication server.

The communication control method according to another embodiment further comprises the steps of: setting, by the first authentication server, the second authentication server to the valid authentication server for the user terminal; and cancelling, by the first authentication server, setting of the second authentication server, when a frequency of a traffic transition of the user terminal between the first communication system and the second communication system is less than a threshold value.

An authentication server according to an embodiment is an authentication server configured to authenticate a connection of a user terminal to a first communication system. The authentication server comprises: a transmitter configured to transmit a first encryption key to the user terminal; a receiver configured to receive encrypted information in which information on the user terminal in the first communication system is encrypted from another authentication server in a second communication system; and a controller configured to determine that the another authentication server is, for the user terminal, a valid authentication server, when the controller acquires information on the user terminal in the first communication system by decrypting the encrypted information by using a first decryption key capable of decrypting information encrypted by the first encryption key.

A user terminal according to an embodiment is a user terminal capable of being used in a first communication system and a second communication system. The user terminal comprises: a receiver configured to receive a first encryption key from a first authentication server in the first communication system; and a transmitter configured to transmit, when receiving the first encryption key, terminal information on the user terminal in the first communication system to a second authentication server in the second communication system. The first encryption key is used for encryption of the terminal information.

### Embodiment

Hereinafter, with reference to the accompanying drawings, the following description will be provided for embodiment in a case where a cellular communication system (an LTE system) configured in compliance with 3GPP standards is allowed to cooperate with a Wireless LAN (WLAN) system.

(System Configuration)

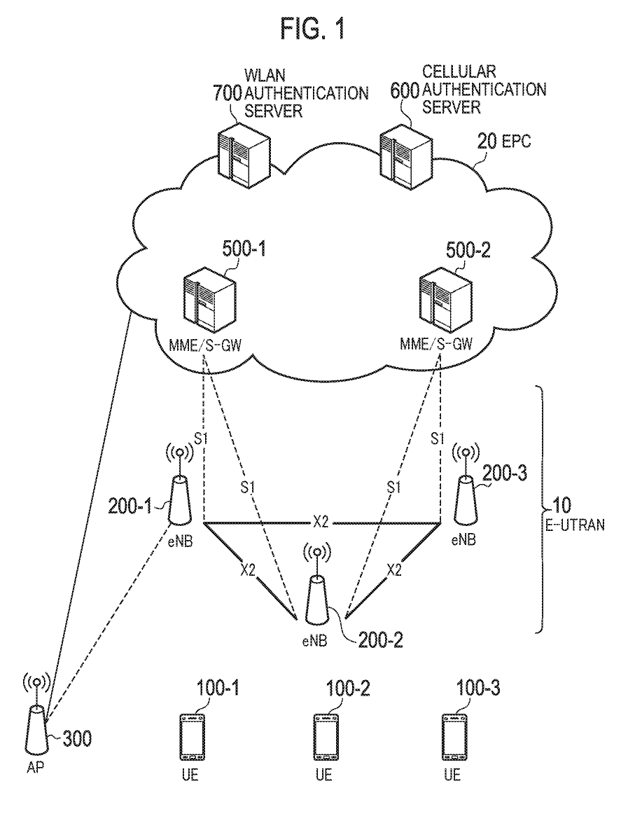

FIG. 1 is a configuration diagram of a system according to the embodiment. As illustrated in FIG. 1, the cellular communication system includes a plurality of UEs (User Equipments) 100, E-UTRAN (Evolved Universal Terrestrial Radio Access Network) 10, and EPC (Evolved Packet Core) 20. The E-UTRAN 10 corresponds to a radio access network. The EPC 20 corresponds to a core network.

The UE 100 is a mobile radio communication device and performs radio communication with a cell with which a connection is established. The UE 100 corresponds to the user terminal. The UE 100 is a terminal (a dual terminal) supporting communication methods of both cellular communication and WLAN communication.

The E-UTRAN 10 includes a plurality of eNBs 200 (evolved Node-Bs). The eNB 200 corresponds to a cellular base station. The eNB 200 manages one or a plurality of cells (large cell(s)) and performs radio communication with the UE 100 having established a connection (RRC connection) with the cell of the eNB 200.

It is noted that the “cell” is used as a term indicating a minimum unit of a radio communication area, and is also used as a term indicating a function of performing radio communication with the UE 100.

The eNB 200, for example, has a radio resource management (RRM) function, a routing function of user data, and a measurement control function for mobility control and scheduling.

In addition, the eNBs 200 are connected mutually via an X2 interface. Furthermore, the eNB 200 is connected to the MME/S-GW 500 included in the EPC 20 via an Si interface.

The EPC 20 includes a plurality of MMEs (Mobility Management Entities)/S-GWs (Serving-Gateways) 500. The MME is a network node for performing various mobility controls, for example, for the UE 100 and corresponds to a control station. The S-GW is a network node that performs transfer control of user data and corresponds to a mobile switching center.

The WLAN system includes a WLAN AP (hereinafter, referred to as an “AP”) 300. The WLAN system is configured in compliance with IEEE 802.11 standards, for example. The AP 300 performs communication with the UEs 100 in a frequency band (WLAN frequency band) different from a cellular frequency band. The AP 300 is connected to the EPC 20 via a router or the like.

It is noted that the eNB 200 and the AP 300 may be individually located, and in addition, may be collocated. As one mode of the “Collocated”, the eNB 200 and the AP 300 may be directly connected to each other through any interface of an operator.

The EPC 20 further includes a cellular authentication server 600 that performs a network authentication of the UE 100 in the cellular communication system and a WLAN authentication server 700 that performs a network authentication of the UE 100 in the WLAN system.

The cellular authentication server 600 includes a network interface, a memory, and a processor. The memory and the processor configure a controller. The network interface configures a transmitter and a receiver. The network interface and the processor execute various types of processes and various types of communication protocols described later. It is noted that the WLAN authentication server 700 also has configuration similar to that of the cellular authentication server 600.

When succeeding the network authentication by the cellular authentication server 600, the UE 100 becomes connectable to the cellular communication system. Further, when succeeding the network authentication by the WLAN authentication server 700, the UE 100 becomes connectable to the WLAN system.

Next, the configurations of the UE 100, the eNB 200, and the AP 300 will be described.

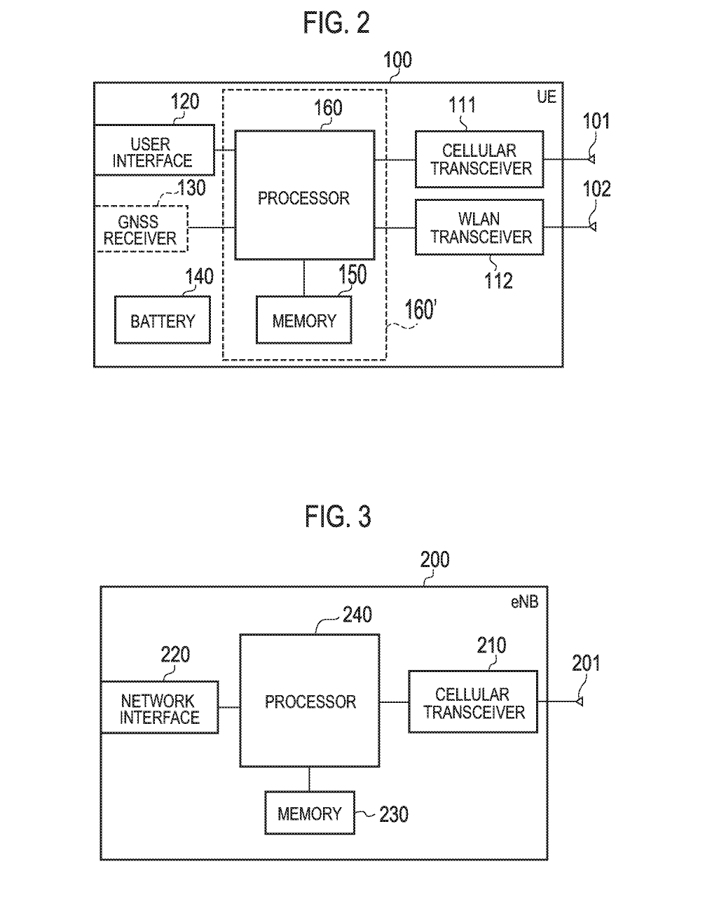

FIG. 2 is a block diagram of the UE 100. As illustrated in FIG. 2, the UE 100 has antennas 101 and 102, a cellular transceiver 111, a WLAN transceiver 112, a user interface 120, a GNSS (Global Navigation Satellite System) receiver 130, a battery 140, a memory 150, and a processor 160. The memory 150 and the processor 160 constitute a controller. The UE 100 may not have the GNSS receiver 130. Furthermore, the memory 150 may be integrally formed with the processor 160, and this set (that is, a chipset) may be called a processor 160′.

The antenna 101 and the cellular transceiver 111 are used for transmitting and receiving cellular radio signals. The cellular transceiver 111 converts a baseband signal output by the processor 160 to a cellular radio signal, and transmits it from the antenna 101. The cellular transceiver 111 also converts a cellular radio signal received by the antenna 101 to a baseband signal, and outputs it to the processor 160.

The antenna 102 and the WLAN transceiver 112 are used for transmitting and receiving WLAN radio signals. The WLAN transceiver 112 converts a baseband signal output by the processor 160 to a WLAN radio signal, and transmits it from the antenna 102. The WLAN transceiver 112 also converts a WLAN radio signal received by the antenna 102 to a baseband signal, and outputs it to the processor 160.

A MAC address (hereinafter, referred to as a “WLAN MAC-ID”) is allocated to the WLAN transceiver 112 as an identifier of the UE 100 in the WLAN system. A WLAN radio signal transmitted and received by the WLAN transceiver 112 includes the WLAN MAC-ID.

The user interface 120 is an interface with a user carrying the UE 100, and includes, for example, a display, a microphone, a speaker, various buttons and the like. The user interface 120 receives an input from a user and outputs a signal indicating the content of the input to the processor 160. The GNSS receiver 130 receives a GNSS signal in order to obtain location information indicating a geographical location of the UE 100, and outputs the received signal to the processor 160. The battery 140 accumulates a power to be supplied to each block of the UE 100.

The memory 150 stores a program to be executed by the processor 160 and information to be used for a process by the processor 160. The processor 160 includes a baseband processor that performs modulation and demodulation, encoding and decoding and the like of the baseband signal, and a CPU that performs various processes by executing the program stored in the memory 150. The processor 160 may further include a codec that performs encoding and decoding of sound and video signals. The processor 160 implements various processes and various communication protocols described later.

FIG. 3 is a block diagram of the eNB 200. As illustrated in FIG. 3, the eNB 200 has an antenna 201, a cellular transceiver 210, a network interface 220, a memory 230, and a processor 240. The memory 230 and the processor 240 constitute a controller. Note that, the memory 230 may be integrally formed with the processor 240, and this set (that is, a chipset) may be called a processor.

The antenna 201 and the cellular transceiver 210 are used to transmit and receive a radio signal. The cellular transceiver 210 converts a baseband signal output by the processor 240 to a cellular radio signal, and transmits it from the antenna 201. The cellular transceiver 210 also converts a cellular radio signal received by the antenna 201 to a baseband signal, and outputs it to the processor 240.

The network interface 220 is connected to a neighboring eNB 200 via the X2 interface and is connected to the MME/S-GW 500 via the Si interface. Further, the network interface 220 is used in communication with the AP 300 via the EPC 20.

The memory 230 stores a program to be executed by the processor 240 and information to be used for a process by the processor 240. The processor 240 includes a baseband processor that performs modulation and demodulation, encoding and decoding and the like of the baseband signal and a CPU that performs various processes by executing the program stored in the memory 230. The processor 240 implements various processes and various communication protocols described later.

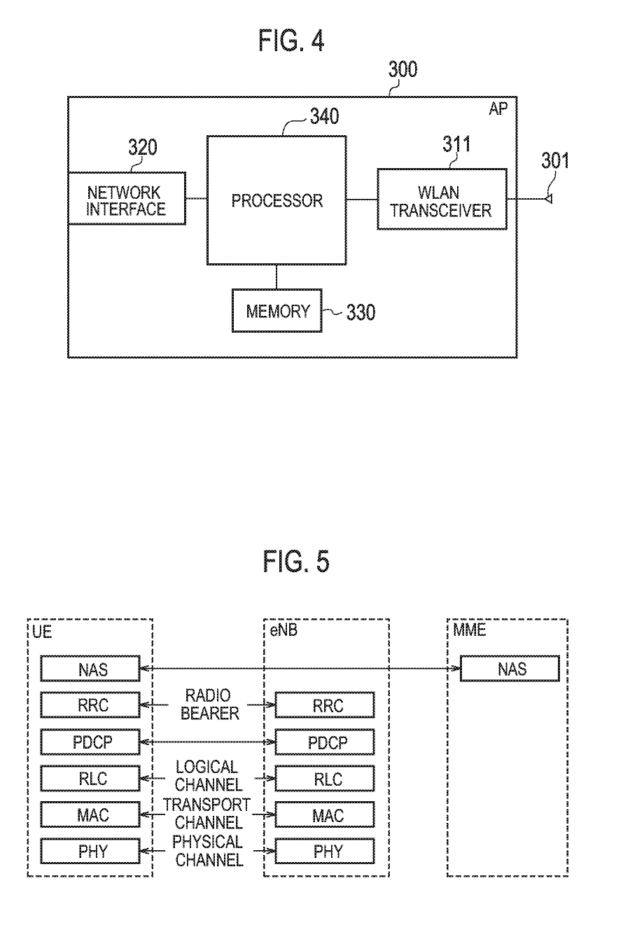

FIG. 4 is a block diagram of the AP 300. As illustrated in FIG. 3, the AP 300 has an antenna 301, a WLAN transceiver 311, a network interface 320, a memory 330, and a processor 340. The memory 330 and the processor 340 constitute a controller. Note that, the memory 330 may be integrally formed with the processor 340, and this set (that is, a chipset) may be called a processor.

The antenna 301 and the WLAN transceiver 311 are used to transmit and receive a WLAN radio signal. The WLAN transceiver 311 converts a baseband signal output by the processor 340 to a WLAN radio signal, and transmits it from the antenna 301. The WLAN transceiver 311 also converts a WLAN radio signal received by the antenna 301 to a baseband signal, and outputs it to the processor 340.

The network interface 420 is connected to the EPC 20 via a router etc. Further, the network interface 320 is used in communication with the eNB 200 via the EPC 20.

The memory 330 stores a program to be executed by the processor 340 and information to be used for a process by the processor 340. The processor 340 includes a baseband processor that performs modulation and demodulation, encoding and decoding and the like of the baseband signal and a CPU that performs various processes by executing the program stored in the memory 330.

FIG. 5 is a protocol stack diagram of a radio interface in the cellular communication system. As illustrated in FIG. 5, the radio interface protocol is classified into a layer 1 to a layer 3 of an OSI reference model, wherein the layer 1 is a physical (PHY) layer. The layer 2 includes a MAC (Medium Access Control) layer, an RLC (Radio Link Control) layer, and a PDCP (Packet Data Convergence Protocol) layer. The layer 3 includes an RRC (Radio Resource Control) layer.

The physical layer performs encoding and decoding, modulation and demodulation, antenna mapping and demapping, and resource mapping and demapping. Between the physical layer of the UE 100 and the physical layer of the eNB 200, data is transmitted through the physical channel.

The MAC layer performs preferential control of data, and a retransmission process and the like by hybrid ARQ (HARQ). Between the MAC layer of the UE 100 and the MAC layer of the eNB 200, data is transmitted via a transport channel. The MAC layer of the eNB 200 includes a scheduler for selecting a transport format of an uplink and a downlink (a transport block size, a modulation and coding scheme and the like) and a resource block to be assigned.

The RLC layer transmits data to an RLC layer of a reception side by using the functions of the MAC layer and the physical layer. Between the RLC layer of the UE 100 and the RLC layer of the eNB 200, data is transmitted via a logical channel.

The PDCP layer performs header compression and decompression, and encryption and decryption.

The RRC layer is defined only in a control plane. Between the RRC layer of the UE 100 and the RRC layer of the eNB 200, a control message (an RRC message) for various types of setting is transmitted. The RRC layer controls the logical channel, the transport channel, and the physical channel in response to establishment, re-establishment, and release of a radio bearer. When a connection (an RRC connection) is established between the RRC of the UE 100 and the RRC of the eNB 200, the UE 100 is in a connected state (RRC connected state), and when the RRC connection is not established, the UE 100 is in an idle state (RRC idle state).

A NAS (Non-Access Stratum) layer positioned above the RRC layer performs session management and mobility management, for example.

(Operation According to Embodiment)

Next, an operation according to the embodiment will be described.

(1) Setting of Authentication Target

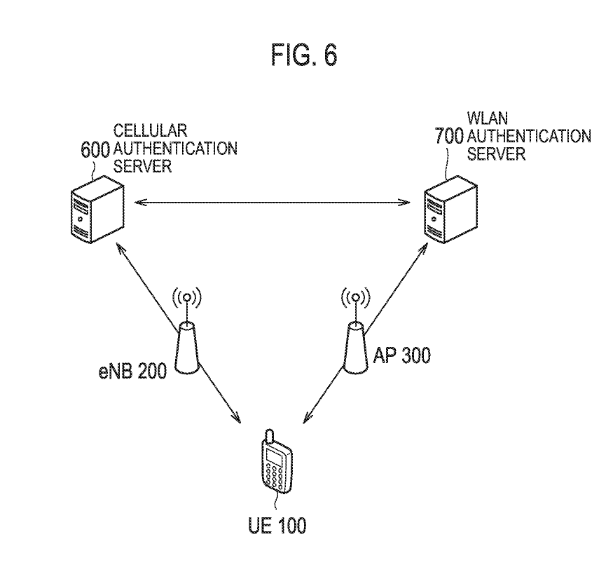

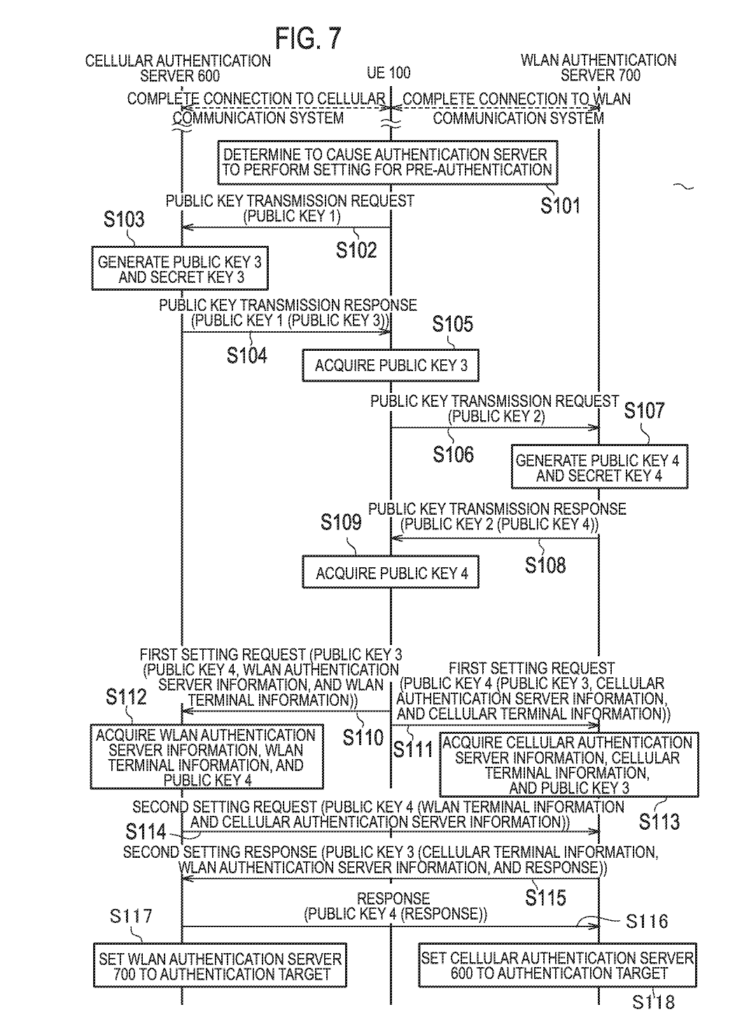

An operation sequence of setting an authentication target according to the present embodiment will be described by using FIG. 6 and FIG. 7. FIG. 6 is a diagram for describing an operation environment according to the embodiment. FIG. 7 is a diagram for describing an operation sequence of setting the authentication target according to the embodiment.

Description proceeds with an assumption that in the present embodiment, the UE 100 succeeds the network authentication by the cellular authentication server 600 and thus is connectable to the cellular communication system. In addition, description proceeds with an assumption that the UE 100 succeeds the network authentication by the WLAN authentication server 700 and thus is connectable to the WLAN communication system. That is, the UE 100 is connected both to the cellular communication system and the WLAN communication system. Therefore, as shown in FIG. 6, the UE 100 performs the communication with the cellular authentication server 600 by way of the eNB 200, and performs the communication with the WLAN authentication server 700 by way of the AP 300. Further, the cellular authentication server 600 and the WLAN authentication server 700 perform the communication via a network.

It is noted that in the present embodiment, a communication operator that manages the cellular authentication server 600 is different from a communication operator that manages the WLAN authentication server.

As shown in FIG. 7, in step S101, the UE 100 determines to cause the authentication servers (the cellular authentication server 600 and the WLAN authentication server 700) to perform setting of the authentication target for pre-authentication between the cellular communication system and the WLAN communication system. Specifically, the UE 100 determines to cause the cellular authentication server 600 to set the WLAN authentication server 700 to the authentication target (that is, a valid authentication server) for the UE 100 in the WLAN communication system, and determines to cause the WLAN authentication server 700 to set the cellular authentication server 600 to the authentication target for the UE 100 in the cellular communication system.

For example, when a frequency of a traffic transition between the cellular communication system and the WLAN communication system exceeds a threshold value, the UE 100 determines to cause the authentication server to perform the setting for pre-authentication. Alternatively, a user of the UE 100 selects a communication system (that is, a radio service) in which the pre-authentication for performing offload between different communication systems is permitted. The UE 100 determines to cause the authentication server to perform the setting for the pre-authentication between the selected communication systems.

The UE 100 generates a public key 1 and a secret key 1. The secret key 1 is a key capable of decrypting information encrypted by the public key 1. Further, the UE 100 generates a public key 2 and a secret key 2. The secret key 2 is a key capable of decrypting information encrypted by the public key 2.

In step S102, the UE 100 transmits a public key transmission request for causing the authentication server of the UE 100 in a different communication system to set to the authentication target, to the cellular authentication server 600. The cellular authentication server 600 receives the public key transmission request.

The public key transmission request is to request a public key generated by the authentication server. The public key is a key for confirming that the authentication server is valid for the UE 100. In the present embodiment, the public key transmission request in step S102 includes the public key 1.

In the present embodiment, when connecting both to the cellular communication system and the WLAN communication system, the UE 100 transmits the public key transmission request.

In step S103, the cellular authentication server 600 generates a public key 3 and a secret key 3, in response to reception of the public key transmission request.

The cellular authentication server 600 uses the public key 1 included in the public key transmission request to encrypt the generated public key 3.

In step S104, the cellular authentication server 600 transmits the public key 3 encrypted by using the public key 1, to the UE 100. The UE 100 receives the encrypted public key 3.

In step S105, the UE 100 uses the secret key 1 to decrypt the encrypted public key 3. Thus, the UE 100 acquires the public key 3.

In step S106, similarly to step S102, the UE 100 transmits the public key transmission request to the WLAN authentication server 700. The WLAN authentication server 700 receives the public key transmission request. Similarly to step S102, the public key transmission request includes the public key 2.

In step S107, similarly to step S103, the WLAN authentication server 700 generates a public key 4 and a secret key 4, in response to reception of the public key transmission request.

The WLAN authentication server 700 uses the public key 2 included in the public key transmission request to encrypt the generated public key 4.

In step S108, similarly to step S104, the WLAN authentication server 700 transmits the public key 4 encrypted by using the public key 2, to the UE 100. The UE 100 receives the encrypted public key 4.

In step S109, similarly to step S105, the UE 100 uses the secret key 2 to decrypt the encrypted public key 4. Thus, the UE 100 acquires the public key 4.

In step S110, the UE 100 transmits a first setting request to the cellular authentication server 600. Specifically, the UE 100 uses the public key 3 to encrypt the first setting request, and transmits the encrypted first setting request to the cellular authentication server 600. The cellular authentication server 600 receives the first setting request.

The first setting request is a request to cause to set the authentication server of the UE 100 in a different communication system to the authentication target, and is a request transmitted from the UE 100 to the authentication server.

In the present embodiment, the first setting request includes the public key (public key 4) acquired from the authentication server in another communication system, the information (WLAN authentication server information) on the authentication server in the other communication system, and the information (WLAN terminal information) on the UE 100 in the other communication system.

In the present embodiment, the WLAN authentication server information includes a destination (address) of the WLAN authentication server 700. Further, the WLAN terminal information includes an identifier (WLAN MAC-ID) of the UE 100 in the WLAN communication system.

In step S111, similarly to step S110, the UE 100 transmits the first setting request to the WLAN authentication server 700. The UE 100 uses the public key 4 to encrypt the first setting request, and transmits the encrypted first setting request to the WLAN authentication server 700. The WLAN authentication server 700 receives the first setting request.

Here, the first setting request in step S111 includes the public key 3, the cellular authentication server information, and the cellular terminal information. The cellular authentication server information includes a destination (address) of the cellular authentication server 600. The cellular terminal information includes an identifier (UE-ID) of the UE 100 in the cellular communication system.

In step S112, the cellular authentication server 600 uses the secret key 3 to decrypt the encrypted first setting request. As a result, the cellular authentication server 600 acquires the public key 4, the WLAN authentication server information, and the WLAN terminal information included in the first setting request.

In step S113, the WLAN authentication server 700 uses the secret key 4 to decrypt the encrypted first setting request. As a result, the WLAN authentication server 700 acquires the public key 3, the cellular authentication server information, and the cellular terminal information included in the first setting request.

In step S114, the cellular authentication server 600 transmits a second setting request to the WLAN authentication server 700. Specifically, the cellular authentication server 600 uses the public key 4 acquired from the UE 100 to encrypt the second setting request, and transmits the encrypted second setting request to the WLAN authentication server 700. The WLAN authentication server 700 receives the second setting request.

The second setting request is a request to cause to set the authentication server of the UE 100 in a different communication system to the authentication target, and is a request transmitted from the authentication server to another authentication server.

In the present embodiment, the second setting request includes the information (WLAN terminal information) on the UE 100 in the communication system of a transmission target and the information (cellular authentication server information) on the authentication server.

Here, the terminal information includes an identifier (WLAN MACID) of the UE 100 in the communication system. Further, the cellular authentication server information includes authentication setting information used for authentication of the UE 100 in the cellular authentication server 600 (network authentication of the UE 100). Therefore, when the WLAN authentication server 700, instead of the UE 100, transmits the authentication setting information to the cellular authentication server 600 before the offload, the cellular authentication server 600 is capable of authenticating the UE 100, on the basis of the authentication setting information received from the WLAN authentication server 700. As a result, it is possible to omit the transmission of the authentication setting information from the UE 100 and perform a smooth offload.

It is noted that the second setting request may include the WLAN authentication server information acquired from the UE 100.

On the other hand, the WLAN authentication server 700 uses the secret key 4 to decrypt the encrypted second setting request. As a result, the WLAN authentication server 700 acquires the WLAN terminal information and the cellular authentication server information. When acquiring from the cellular authentication server 600 an identifier of the UE 100 in the WLAN communication system, where the identifier is information not normally known by the cellular authentication server 600 that is the authentication server in a different communication system, the WLAN authentication server 700 determines that the cellular authentication server 600 is, for the UE 100, a valid authentication server.

In step S115, the WLAN authentication server 700 transmits the response (second setting response) to the second setting request, to the cellular authentication server 600. Specifically, the cellular authentication server 600 uses the public key 3 acquired from the UE 100 to encrypt the second setting response, and transmits the encrypted second setting response to the cellular authentication server 600. The cellular authentication server 600 receives the second setting response.

The second setting response is a response to the second setting request. Further, similarly to the second setting request, the second setting response is also a request to cause to set the authentication server of the UE 100 in a different communication system to the authentication target, and is a request transmitted from the authentication server to another authentication server.

In the present embodiment, the second setting response includes the cellular terminal information, the WLAN authentication server information, and the response to the second setting request. The response may include information indicating that the WLAN authentication server 700 determines that the cellular authentication server 600 is, for the UE 100, the valid authentication server.

The cellular authentication server 600 uses the secret key 3 to decrypt the encrypted second setting response. As a result, the cellular authentication server 600 acquires the cellular terminal information, the WLAN authentication server information, and the response to the second setting request. When acquiring an identifier of the UE 100 in the cellular communication system, where the identifier is information not normally known by the WLAN authentication server 700 that is the authentication server in a different communication system, the cellular authentication server 600 determines that the WLAN authentication server 700 is, for the UE 100, the valid authentication server.

In step S116, the cellular authentication server 600 transmits a response to the second setting response to the WLAN authentication server 700. Specifically, the cellular authentication server 600 uses the public key 4 to encrypt the response to the second setting response, and transmits the encrypted second setting response to the WLAN authentication server 700. The WLAN authentication server 700 receives the response to the second setting response. The response may include information indicating that the cellular authentication server 600 determines that the WLAN authentication server 700 is, for the UE 100, the valid authentication server.

The WLAN authentication server 700 uses the secret key 4 to decrypt the encrypted response. As a result, the WLAN authentication server 700 acquires the response.

In step S117, the cellular authentication server 600 sets the WLAN authentication server 700 to the (pre-)authentication target of the UE 100.

In step S118, the WLAN authentication server 700 sets the cellular authentication server 600 to the (pre-)authentication target of the UE 100.

It is noted that the cellular authentication server 600 and the WLAN authentication server 700 may report, to the UE 100, that the both servers 600 and 700 mutually set themselves to the authentication target of the UE 100.

Thereafter, when it is determined that the traffic of the UE 100 is transitioned from the cellular communication system to the WLAN communication system, the cellular authentication server 600 is capable of requesting the network authentication of the UE 100, to the WLAN authentication server 700 to which the authentication target of the UE 100 in the WLAN communication system is set. Further, likewise, the WLAN authentication server 700 is also capable of requesting the network authentication of the UE 100, to the cellular authentication server 600.

(2) Update of Authentication Target

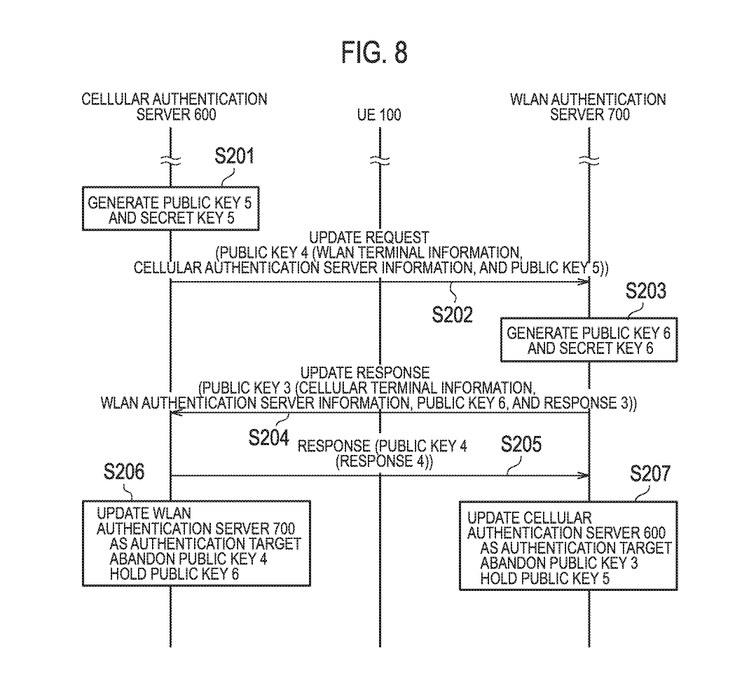

Next, an operation sequence of updating an authentication target according to the present embodiment will be described by using FIG. 8. FIG. 8 is a diagram for describing an operation sequence of updating an authentication target according to the embodiment.

As shown in FIG. 8, in step S201, the cellular authentication server 600 generates a public key 5 and a secret key 5. For example, when a predetermined period passes since the public key 3 is generated, the cellular authentication server 600 generates the public key 5 and the secret key 5.

In step S202, the cellular authentication server 600 transmits an update request to update the authentication target, to the WLAN authentication server 700. Specifically, the cellular authentication server 600 uses the public key 4 to encrypt the update request, and transmits the encrypted update request to the WLAN authentication server 700. The WLAN authentication server 700 receives the update request.

The update request includes the WLAN terminal information, the cellular authentication server information, and the public key 5. The WLAN terminal information and the cellular authentication server information are information similar to the above-described second setting request.

The WLAN authentication server 700 uses the secret key 4 to decrypt the update request. As a result, the WLAN authentication server 700 acquires the WLAN terminal information, the cellular authentication server information, and the public key 5.

In step S203, the WLAN authentication server 700 generates a public key 6 and a secret key 6. When a predetermined time passes since the public key 4 is generated, the WLAN authentication server 700 may generate the public key 6 and the secret key 6, and may generate the public key 6 and the secret key 6 in response to reception of the update request from the cellular authentication server 600.

In step S204, the WLAN authentication server 700 transmits a response to the update request. Specifically, the WLAN authentication server 700 uses the public key 3 to encrypt the response, and transmits the encrypted response to the cellular authentication server 600. The cellular authentication server 600 receives the response.

The update response includes the cellular terminal information, the WLAN authentication server information, the public key 6, and the response to the update request. The cellular terminal information and the WLAN authentication server information are information similar to the above-described second setting response. The response may include information indicating that the WLAN authentication server 700 determines that the cellular authentication server 600 is, for the UE 100, the valid authentication server.

The cellular authentication server 600 uses the secret key 3 to decrypt the update response. As a result, the cellular authentication server 600 acquires the cellular terminal information, the WLAN authentication server information, the public key 6, and the response.

In step S205, the cellular authentication server 600 transmits a response to the update response, to the WLAN authentication server. Specifically, the cellular authentication server 600 uses the public key 4 to encrypt the response to the update response, and transmits the response to the encrypted update response, to the WLAN authentication server 700.

The WLAN authentication server 700 uses the secret key 4 to decrypt the encrypted response. As a result, the WLAN authentication server 700 acquires the response. The response may include information indicating that the cellular authentication server 600 determines that the WLAN authentication server 700 is, for the UE 100, the valid authentication server.

In step S206, the cellular authentication server 600 updates by setting the WLAN authentication server 700 to the authentication target of the UE 100. Further, the cellular authentication server 600 abandons the public key 4 and holds the public key 6 instead of the public key 4.

In step S207, similarly to step S206, the WLAN authentication server 700 updates by setting the cellular authentication server 600 to the authentication target of the UE 100. Further, the WLAN authentication server 700 abandons the public key 3 and holds the public key 5 instead of the public key 3.

(3) Summary

In the present embodiment, the cellular authentication server 600 transmits the public key 3 to the UE 100. The UE 100 transmits the public key 3 and the cellular terminal information to the WLAN authentication server 700. The WLAN authentication server 700 uses the public key 3 to encrypt the cellular terminal information. The WLAN authentication server 700 transmits the encrypted cellular terminal information to the cellular authentication server 600. When being capable of acquiring the cellular terminal information by using the secret key 3, the cellular authentication server 600 determines that the WLAN authentication server 700 is, for the UE 100, the valid authentication server. As a result, when receiving, from the WLAN authentication server 700, the public key 3 that is the information not known by the WLAN authentication server 700 and the cellular terminal information, the cellular authentication server 600 is also capable of regarding that the UE 100 guarantees that the WLAN authentication server 700 is, for the UE 100, the valid authentication server. Further, in the same way, when receiving from the cellular authentication server 600 the public key 4 that is the information not known by the cellular authentication server 600 and the WLAN terminal information, the WLAN authentication server 700 is capable of regarding that the UE 100 guarantees that the cellular authentication server 600 is, for the UE 100, the valid authentication server. Therefore, between the cellular authentication server 600 and the WLAN authentication server 700, it is possible to confirm the authentication server is valid for the UE 100, it is possible to ensure the reliability that between the different communication systems, the cellular authentication server 600 and the WLAN authentication server 700 are, for the UE 100, the valid authentication server.

In the present embodiment, a communication operator that manages the cellular authentication server 600 is different from a communication operator that manages the WLAN authentication server 700. The communication operators are different, and thus, even when an inquiry destination to inquire the authentication server of the UE 100 in the other communication system is not known, or even when there is no answer to the inquiry, it is possible to confirm, according to the above embodiment, the valid authentication server.

In the present embodiment, before receiving the public key 3 from the cellular authentication server 600, the UE 100 transmits the public key transmission request to the cellular authentication server 600. The public key request includes the public key 1 used for encrypting the public key 3. When receiving the public key transmission request from the UE 100, the cellular authentication server 600 transmits the public key 3 encrypted by using the public key 1, to the UE 100. As a result, a possibility that another authentication server acquires the public key 3 transmitted to the UE 100 decreases, and thus, it is possible to improve the reliability that the authentication server is, for the UE 100, the valid authentication server.

In the present embodiment, when connecting both to the cellular communication system and the WLAN communication system, the UE 100 transmits the public key transmission request, to the cellular authentication server 600. As a result, it is possible to transmit the public key 3 to the WLAN authentication server 700 immediately after acquiring the public key 3 from the cellular authentication server 600, and thus, it is possible to transmit the public key 3 within an expiration even when the public key 3 has the expiration.

In the present embodiment, the WLAN authentication server 700 is capable of transmitting, together with the cellular terminal information, the authentication setting information that is encrypted by using the public key 3 and is used for authenticating the UE 100 in the WLAN authentication server 700, to the cellular authentication server 600. The cellular authentication server 600, instead of the UE 100, is capable of transmitting, before the traffic of the UE 100 is offloaded from the cellular communication system to the WLAN communication system, the authentication setting information to the WLAN authentication server 700. The WLAN authentication server 700 is capable of performing the network authentication of the UE 100 on the basis of the authentication setting information received from the cellular authentication server 600. As a result, the pre-authentication is performed before the offload, and thus, it is possible to execute a smooth offload.

In the present embodiment, when determining that the cellular authentication server 600 is the valid authentication server, the WLAN authentication server 700 is capable of transmitting, as the response to the WLAN terminal information (second setting request), the encrypted cellular terminal information, to the cellular authentication server 600. As a result, the WLAN authentication server 700 is capable of preventing transmission of the WLAN terminal information to the authentication server that is not the valid authentication server.

It is noted that an operation for only either one of the cellular authentication server 600 and the WLAN authentication server 700 is described and the other operation is not described, where appropriate; however, it is naturally possible to obtain a similar operation and publication also in the other authentication server. The same applies, below.

### Modification of Embodiment

Next, an operation according to a modification of the embodiment will be described.

(1) Setting of Authentication Target

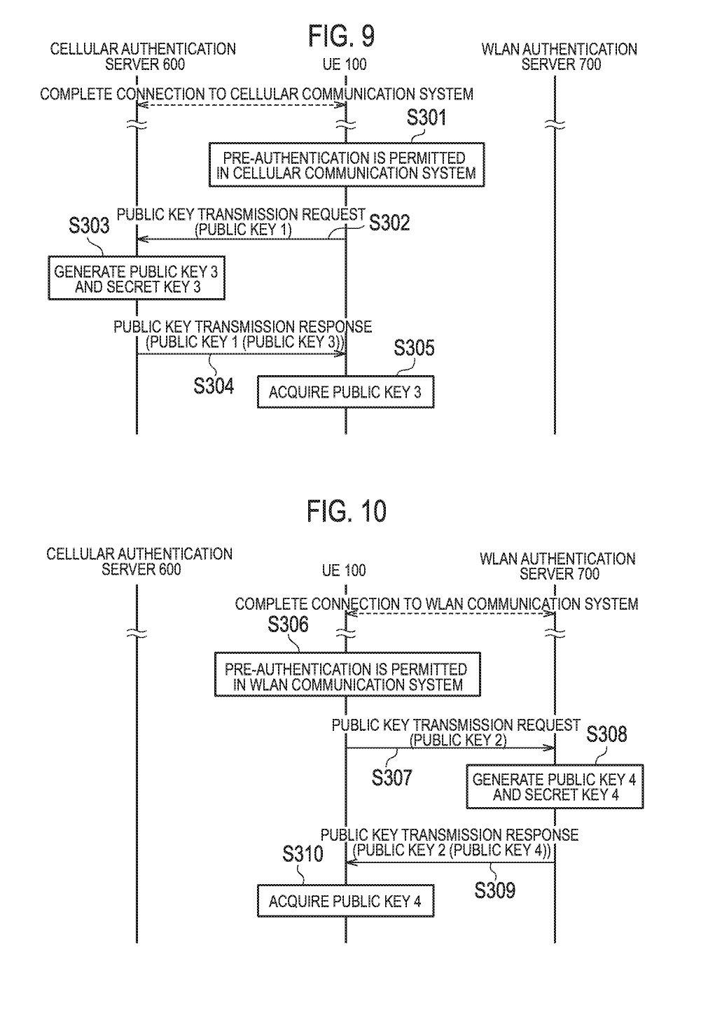

An operation sequence of setting an authentication target according to a modification of the present embodiment will be described by using FIG. 9 to FIG. 12. FIG. 9 to FIG. 12 are diagrams for describing an operation sequence of setting the authentication target according to the modification of the embodiment. It is noted that a description will be provided while focusing on a portion different from the above-described embodiment, and a description of a similar portion will be omitted, where necessary.

In the above-described embodiment, the UE 100 is connected both to the cellular communication system and the WLAN communication system. In the modification, the UE 100 is connected only to one of the cellular communication system and the WLAN communication system. Specifically, as shown in FIG. 9, the UE 100 is connected to the cellular communication system.

In step S301, the UE 100 determines whether or not a communication system to which the UE 100 is connected is a communication system in which the pre-authentication is permitted. For example, a user of the UE 100 selects a communication system in which the pre-authentication for performing offload between different communication systems is permitted. Alternatively, the user of the UE 100 (previously) registers the communication system in which the pre-authentication is permitted. When the communication system to which the UE 100 is connected is selected as the communication system in which the pre-authentication is permitted (or is registered), the UE 100 determines that the communication system to which the UE 100 is connected is the communication system in which the pre-authentication is permitted, and executes a process of step S302.

It is noted that when the communication system to which the UE 100 is connected is not the communication system in which the pre-authentication is permitted, the UE 100 is capable of ending the process.

In the present modification, description proceeds with an assumption that the cellular communication system is the communication system in which the pre-authentication is permitted.

Steps S302 to S305 correspond to steps S102 to S105 in FIG. 7.

Next, as shown in FIG. 10, description proceeds with an assumption that the UE 100 is disconnected with the cellular communication system and is connected to the WLAN communication system.

In step S306, similarly to step S301, the UE 100 determines whether or not a communication system to which the UE 100 is connected is a communication system in which the pre-authentication is permitted. In the present modification, description proceeds with an assumption that the WLAN communication system is the communication system in which the pre-authentication is permitted.

Steps S307 to S310 correspond to steps S106 to S109 in FIG. 7.

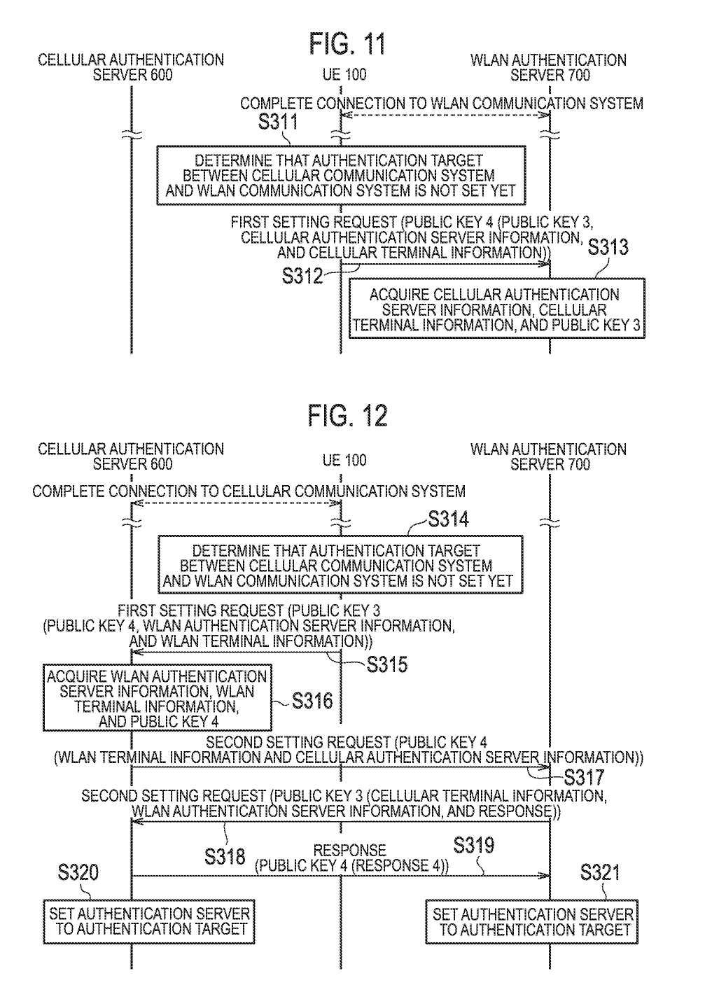

As shown in FIG. 11, in step S311, the UE 100 determines whether or not, between different communication systems, the respective authentication servers set the authentication server of the partner system to the authentication target. Specifically, the UE 100 determines whether or not the authentication server (WLAN authentication server 700) in the WLAN communication system connected thereto sets the cellular authentication server 600 to the authentication target.

For example, when not transmitting to the WLAN authentication server 700 the public key 3 from the cellular authentication server 600 that is the authentication server in the cellular communication system in which the pre-authentication is permitted, the UE 100 determines that the WLAN authentication server 700 does not yet set the authentication target in the cellular communication system. Alternatively, the UE 100 acquires, from the authentication server, authentication target information indicating the set authentication target, and on the basis of the authentication target information, makes a determination. In the present modification, description proceeds with an assumption that the UE 100 determines that the WLAN authentication server 700 does not yet set the authentication target.

It is noted that when determining that the WLAN authentication server 700 sets the authentication target in the cellular communication system, the UE 100 is capable of ending the process.

Steps S312 and S313 correspond to steps S111 and S113 in FIG. 7.

Next, as shown in FIG. 12, description proceeds with an assumption that the UE 100 is disconnected with the cellular communication system and is connected to the WLAN communication system.

As shown in FIG. 12, in step S314, similarly to step S311, the UE 100 determines whether or not the authentication server (cellular authentication server 600) in the cellular communication system connected thereto sets the WLAN authentication server 700 to the authentication target. In the present modification, description proceeds with an assumption that the UE 100 determines that the cellular authentication server 600 does not yet set the authentication target.

Steps S315 to S321 correspond to steps S110, S112, and S114 to S118 in FIG. 7.

It is noted that when determining that the cellular authentication server 600 sets the authentication target in the WLAN communication system, the UE 100 is capable of ending the process.

(2) Summary

In the present modification, when connecting only to the cellular communication system, the UE 100 transmits the public key transmission request, to the cellular authentication server 600. When performing the connection to the WLAN communication system, the UE 100 transmits the public key 3 acquired from the cellular authentication server 600, to the WLAN authentication server 700. As a result, even when the UE 100 is not connected to the both communication systems (that is, connected only to either one communication system), it is capable of confirming that the cellular authentication server 600 is a valid authentication server for the UE 100.

### Other Embodiments

Thus, the present invention has been described with the embodiments. However, it should not be understood that those descriptions and drawings constituting a part of this disclosure limit the present invention. From this disclosure, a variety of alternate embodiments, examples, and applicable techniques will become apparent to one skilled in the art.

For example, in the above-described embodiment, both the cellular authentication server 600 and the WLAN authentication server 700 use a public key and a secret key to confirm that each of the authentication servers is a valid authentication server for each other; however, this is not limiting. Only either one authentication server (the cellular authentication server 600, for example) may use a public key and a secret key to confirm that the other authentication server (the WLAN authentication server 700, for example) is valid for the one respectively. When the cellular authentication server 600 may use a public key and a secret key to confirm that the WLAN authentication server 700 is the valid authentication server, the cellular authentication server 600 may transmit information acquired through decrypting, to the WLAN authentication server 700, whereby the WLAN authentication server 700 may confirm that the cellular authentication server 600 is the valid authentication server.

Further, in the above-described embodiment, the public key transmission request includes the public key generated by the UE 100; however, this is not limiting. When the security is ensured in the communication with the cellular authentication server 600, the UE 100 may transmit the public key transmission request not including the public key 1, to the cellular authentication server 600. Likewise, the UE 100 may transmit the public key transmission request not including the public key 2, to the WLAN authentication server 700.

Further, in the above-described embodiment, a pair of keys (a public key and a secret key) are used where the information encrypted by either one key (the public key, for example) is decrypted by the other key (the secret key) corresponding to the either one key; however, a common key in which a key used for encryption and a key used for decryption are identical may be used.

Further, in the above-described embodiment, in the update of the authentication target, information for updating the authentication target is exchanged (the update request, the update response, and the response) between the cellular authentication server 600 and the WLAN authentication server 700, without passing through the UE 100; however, this is not limiting. For example, similarly to the “setting of the authentication target” according to the above-described embodiment, the update of the authentication target may be performed.

For example, the cellular authentication server 600 may generate a new public key 7 instead of the public key 3. Likewise, the WLAN authentication server 700 may generate a new public key 8 instead of the public key 4. The cellular authentication server 600 and the WLAN authentication server 700 may use the public key 7 and the public key 8 to confirm that the authentication server is valid, similarly to the above-described embodiment, and then, may update the authentication target.

Further, in the above-described embodiment, the cellular authentication server 600 may cancel the setting of the authentication target under a predetermined condition. Description proceeds with the cellular authentication server 600 as an example, below.

For example, when a frequency of a traffic transition (that is, an offload frequency) of the UE 100 between the cellular communication system and the WLAN communication system is less than a threshold value (the number of times of the offloads after an elapse of a predetermined period is zero, for example), the cellular authentication server 600 may cancel to set the WLAN authentication server 700 to the authentication target of the UE 100. As a result, only the authentication target having a large offload frequencies is capable of maintaining the setting (registration), and thus, the cellular authentication server 600 is capable of effectively utilizing a memory provided in the cellular authentication server 600.

It is noted that when there is a cancel request for the authentication target setting from the UE 100 or the authentication server (WLAN authentication server 700) in the other communication system, the setting of the authentication target may be cancelled. The cellular authentication server 600 may transmit and/or receive the cancel request when the information is exchanged (the update request, the update response, and the response) for updating the authentication target. Further, when the resource of the memory falls below a threshold value, the cellular authentication server 600 may cancel the setting of the authentication target.

In the above-described embodiment, as the WLAN terminal information included in the second setting request, the cellular authentication server 600 may transmit a message in which a WLAN MAC-ID is described rather than a WLAN MAC-ID. After the secret key 4 is used to decrypt the encrypted message, when the WLAN MAC-ID described in the message and the WLAN MAC-ID of the UE 100 to which the public key 4 is transmitted match, the WLAN authentication server 700 may determine that the cellular authentication server 600 is, for the UE 100, the valid authentication server.

Further, the cellular authentication server 600 may store one public key so as to be related with one UE 100, and so as to be related with a plurality of UEs 100.

It is noted that in the above, a portion where only the operation of the cellular authentication server 600 is described may be replaced by the operation of the WLAN authentication server 700.

Further, in the above-described embodiment, the communication operation that manages the cellular authentication server 600 and the communication operator that manages the WLAN authentication server are different; however, the communication operators that manage the cellular authentication server 600 and the WLAN authentication server may be the same.

In the above-described embodiment, the cellular authentication server 600 (the authentication server in either one communication system) acquires from the WLAN authentication server 700 the identifier of the UE 100 in the cellular communication system, as the information not usually known by the WLAN authentication server 700 (the authentication server in the other communication system) to determine that the WLAN authentication server 700 is, for the UE 100, the valid authentication server; however, this is not limiting. The information may be any information related with the UE 100 such as a cell identifier (Cell ID) of a cell in which the UE 100 exists and a temporary identifier (C-RNT) temporarily assigned by a cell (eNB 200) to the UE 100. Further, the information may be information that may be capable of being used in only either one communication system and related with the UE 100, and may be information that may be used only in a communication system operated by either one communication operator (operator) and related with the UE 100.

In the above-described embodiment, either one authentication server uses the public key of the other authentication server to encrypt terminal information of the other authentication server; however, this is not limiting. The UE 100 may use the public key of the other authentication server to encrypt the terminal information of the other authentication server, and may transmit the encrypted terminal information to the one authentication server. As a result, the one authentication server does not need to encrypt the terminal information of the other authentication server to enable transmission of the encrypted terminal information to the other authentication server, and thus, the UE 100 may omit the transmission of the public key of the authentication server.

In the above-described embodiments, as one example of cellular communication system, the LTE system is described; however, the present invention is not limited to the LTE system, and the present invention may be applied to systems other than the LTE system. Further, the present invention may be applied to a combination of the cellular communication system and the WLAN communication system, and in addition, applied to a combination of other communication systems.

It is noted that the entire content of Japanese Patent Application No. 2013-224470 (filed on Oct. 29, 2013) is incorporated in the present specification by reference.

### INDUSTRIAL APPLICABILITY

Thus, the communication control method, the authentication server, and the user terminal according to the present invention, with which it is possible to secure the reliability that an authentication server in another system is, for the user terminal, a valid authentication server between authentication servers in different radio communication systems, are useful in a mobile communication field.

1. A communication control method, comprising:
a first transmission step of transmitting, by a first authentication server in a first communication system, a first encryption key, to a user terminal;
a second transmission step of transmitting, by the user terminal, first terminal information on the user terminal in the first communication system to a second authentication server in a second communication system;
a third transmission step of transmitting, by the second authentication server, the first terminal information encrypted by using the first encryption key, to the first authentication server; and
a determination step of determining, by the first authentication server, that the second authentication server is a valid authentication server for the user terminal, when the first authentication server has acquired the first terminal information by using a first decryption key capable of decrypting information encrypted by the first encryption key.

2. The communication control method according to claim 1, wherein
in the second transmission step, the user terminal transmits, together with the first terminal information, the first encryption key received from the first authentication server, to the second authentication server, and
the communication control method further comprises: a step of encrypting, by the second authentication server, the first terminal information by using the first encryption key received from the user terminal.

3. The communication control method according to claim 1, wherein a communication operator that manages the first authentication server is different from a communication operator that manages the second authentication server.

4. The communication control method according to claim 1, further comprising: a request step of transmitting, by the user terminal, a request to the first authentication server before the first transmission step, the request being for causing to set the valid authentication server in the second communication system to the first authentication server, wherein
the request includes a user encryption key used for encryption of the first encryption key, and
in the first transmission step, when receiving the request from the user terminal, the first authentication server transmits the first encryption key encrypted by using the user encryption key to the user terminal.

5. The communication control method according to claim 4, wherein in the request step, when being connected both to the first communication system and the second communication system, the user terminal transmits the request to the first authentication server.

6. The communication control method according to claim 4, wherein
in the request step, when being connected only to the first communication system, the user terminal transmits the request to the first authentication server, and
in the second transmission step, when performing a connection to the second communication system, the user terminal transmits the first terminal information.

7. The communication control method according to claim 1, wherein
in the second transmission step, the user terminal transmits, together with the first terminal information, the first encryption key received from the first authentication server, to the second authentication server,
in the third transmission step, the second authentication server transmits authentication setting information to the first authentication server together with the first terminal information, the authentication setting information being used for authentication of the user terminal in the second authentication server and being encrypted by using the first encryption key, and
the communication control method further comprises the steps of:
transmitting, by the first authentication server, instead of the user terminal, the authentication setting information to the second authentication server before transitioning a traffic of the user terminal from the first communication system to the second communication system; and
authenticating, by the second authentication server, the user terminal, on the basis of the authentication setting information received from the first authentication server.

8. The communication control method according to claim 1, further comprising the steps of:
transmitting, by the second authentication server, a second encryption key to the user terminal;
transmitting, by the user terminal, second terminal information on the user terminal in the second communication system received from the second authentication server, to the first authentication server;
transmitting, by the first authentication server, the second terminal information encrypted by using the second encryption key, to the second authentication server; and
determining, by the second authentication server, that the first authentication server is the valid authentication server, when the second authentication server has acquired the second terminal information by using a second decryption key capable of decrypting information encrypted by using the second encryption key, wherein
in the third transmission step, the second authentication server transmits the first terminal information encrypted by using the first encryption key to the first authentication server, as a response to the second terminal information from the first authentication server when determining that the first authentication server is the valid authentication server.

9. The communication control method according to claim 1, further comprising the steps of:
setting, by the first authentication server, the second authentication server to the valid authentication server for the user terminal; and
cancelling, by the first authentication server, setting of the second authentication server, when a frequency of a traffic transition of the user terminal between the first communication system and the second communication system is less than a threshold value.

10. An authentication server configured to authenticate a connection of a user terminal to a first communication system, comprising:
a transmitter configured to transmit a first encryption key to the user terminal;
a receiver configured to receive encrypted information in which information on the user terminal in the first communication system is encrypted from another authentication server in a second communication system; and
a controller configured to determine that the another authentication server is a valid authentication server for the user terminal, when the controller acquires information on the user terminal in the first communication system by decrypting the encrypted information by using a first decryption key capable of decrypting information encrypted by the first encryption key.

11. A user terminal capable of being used in a first communication system and a second communication system, comprising:
a receiver configured to receive a first encryption key from a first authentication server in the first communication system; and
a transmitter configured to transmit, when receiving the first encryption key, terminal information on the user terminal in the first communication system to a second authentication server in the second communication system, wherein
the first encryption key is used for encryption of the terminal information.
